(19) United States
(12) Patent Application Publication
(10) Pub. No.: US 2008/0225119 A1
(43) Pub. Date: Sep. 18, 2008

(54) Video Distribution Device

(76) Inventor: Shigeyuki Murata, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/586,731

(22) PCT Filed: Jan. 21, 2005
(86) PCT No.: PCT/JP05/00775

§ 371 Date: Jul. 21, 2006

(30) Foreign Application Priority Data
Jan. 22, 2004 (JP) 2004-014949

(51) Int. Cl. H04N 7/18; H04N 5/232

(52) U.S. Cl. 348/153; 348/207.11; 348/E07.085; 348/E05.042

(57) ABSTRACT

A video display function that enables the user to view video. When a plurality of video signals are displayed on a screen, processes are performed to set at least one pattern of information about the arrangement of video signals on the screen, display a list of arrangement information, select at least one pattern of arrangement information from the displayed arrangement information list, and reproduce video signals on the screen according to the selected arrangement information. A video distribution system distributes video signals through a network to client terminals. The video distribution system manages user accounts, holds user information of each user account, acquires the previous access time of the user account associated with the client terminal currently keeping login to the system according to user information held by the system, and transmits to the client terminal information of whether any alarm-recorded video exists after the previous access time.

### TECHNICAL FIELD

The present invention relates to methods for displaying video, and particularly to a video display method for enabling the user to effectually view video pictures.

### BACKGROUND ART

As Network communications are widely used, a system has been developed that enables remote users to display camera pictures (moving pictures, still pictures and intermittent quasi-moving pictures formed of time-series pictures) on his or her client device such as a personal computer or mobile tool.

This system is used for various different purposes, for example, as a monitoring system for detecting intruders or abnormal things about objects to be managed from video pictures (see Patent document 1).

Patent document 1: JP-A-2003-274383

### DISCLOSURE OF INVENTION

Problem to be solved by the Invention

As the above system becomes widely used, it is desired to provide, for example, an interface that is convenient for the pictures from a plurality of cameras to be effectively displayed when the user views video pictures on the client device.

The present invention, in view of the past circumstance, is to provide a video display method for enabling the user to effectively view video pictures.

### Means for Solving the Problem

A video display method according to the invention has the step of setting at least one pattern about the arrangement of a plurality of video pictures on a screen when the plurality of video pictures are displayed on the screen, the step of displaying a list of the arrangement information set as above, the step of selecting at least one pattern of the arrangement information from the list of the arrangement information displayed as above, and the step of reproducing the video pictures on the screen according to the selected arrangement information.

While phrases of “video pictures displayed” are in the description of the invention, phases of, for example, “video pictures reproduced”, “video pictures viewed” and so on also have the same meaning and they are similarly contained in this invention. In addition, while terms of “video pictures”, “video”, “video signals” and so on are used in the description of the invention, terms of, for example, “video images”, “images” and so on also have the same meaning and they are similarly contained in this invention.

### ADVANTAGES OF THE INVENTION

According to the video display method as mentioned above, the user can effectually view video images.

### BEST MODE FOR CARRYING OUT THE INVENTION

An embodiment of the invention will be described with reference to the drawings.

FIG. 1 shows the whole construction of an embodiment of a video storage distribution system to which the video display method of the invention is applied.

The video storage distribution system shown here has an image storage distribution server 1 provided with a randomly accessible recording device (hereinafter, called the disk unit) 3 that stores data of images (also called video, video pictures, video signals or the like that sometimes include audio signals or sounds), a plurality of Web cameras 5 (5-1˜5-n) connected to the image storage distribution server 1 through a network 4, and a plurality of client terminals 6 (6-1˜6-m). The Web cameras 5-1˜5-n have their own channel numbers, respectively. For example, the Web camera 5-1 is used for channel 1 (ch1), the Web camera 5-2 for channel 2 (ch2), . . . , the Web camera 5-n for channel n (chn). Here, n and m are natural numbers, and n=m is not always necessary.

The image data of each frame of camera images from the Web cameras 5-1˜5-n is compressed according to an image compression system such as JPEG, and transmitted in a form of IP packet to the image storage distribution server 1. In this case, the compressed image data becomes variable-length data that has a different amount of data for each frame. The image storage distribution server 1 extracts the compressed image data (hereinafter, simply called the image data) from each packet received through the network from the Web cameras 5-1˜5-n, and causes the disk unit 3 to store it in the corresponding one of storage regions 30 (30-1˜30-n) for different channels (different sites) that are previously acquired.

The image storage distribution system may have a unitary device that has the functions of both image storage distribution server 1 and disk unit 3 integrated.

Each client terminal 6 requests the image storage distribution server 1 to deliver image data specified by, for example, channel number and frame number. The server 1 responds to the request from the client terminal 6 to send the image data of the specified channel number/frame number read out from the disk unit 3 or deliver the latest image data now held in the cache memory in a form of IP packets to the requesting client terminal 6. The video display method according to this invention is used when the client terminal 6 in the image storage distribution system requests to deliver images.

FIG. 2 is a block diagram of the construction of an example of the image storage distribution server 1. The server 1 has a processor 10, a program storing memory 11 that has various different programs to be executed by the processor 10 and remotely monitoring screen pages for client terminals 6 as described later, a table storing memory 12 for various different tables necessary to record channel-image data and to deliver it to the clients, and a data storing memory 13 that is used as the buffer region for the transmitted and received image frame and as the cache region for the written/read image data. In addition, the server 1 has a network interface 14 for connecting to the network 4, and a disk interface 15 as the connection interface to connect the disk unit 3.

A video display method according to this invention will be described next.

FIG. 3 shows a remotely monitoring screen page that is supplied to and displayed on the terminal screen of the client terminal 6 in an embodiment of the invention. The monitoring screen page shown in FIG. 3 is comprised of five functional areas: a video displaying area 31, a video operation area 32, a multiple operation area 33, a camera information displaying area 34 and an information operation area 35. Those areas will be mentioned in detail. The remotely monitoring screen page of the client terminal is generated as a monitoring page on the Web browser. Each client terminal 6, after booting the Web browser, requests the server 1 to send the monitoring page. The server 1 that received the request for the monitoring page reads out the requested Web page from the program storing memory 11, and transmits it to the client terminal 6. The client terminal 6 displays the received monitoring page on the Web browser.

Here, in order for each client terminal 6 to connect to the image storage distribution server 1, authentication is necessary. FIG. 4 shows a login dialog box in this embodiment of the invention. When a correct login user name and password are entered to login to the server 1, the client terminal 6 is connected to the server 1. In addition, the user name used at the login time is judged if the corresponding user can have the authority over the manual recording that will be described later. For example, the user having administrator power can make manual recording, but general user cannot make manual recording. Therefore, in order to use the manual recording function, it is necessary to login by using the user name that has the manual recording power.

The video displaying area 31 will be mentioned next.

The video displaying area 31 displays the video stored in the server 1 or the live video produced from the Web camera 5. In addition, the video displaying area 31 can make two ways of displaying by switching as follows. It can display a video image of, for example, VGA (Video Graphics Array) size as a single full screen shown in FIG. 5A, and it can display four video images of, for example, QVGA (Quarter VGA) size as four divided screens at a time shown in FIG. 5B. In the four-screen mode, the screen to be handled can be selected by using the mouse. Since the selected screen is surrounded by a frame, the operator (user) can easily recognize which screen is selected. FIG. 5B shows the selection of the upper left one of the four divided screens as indicated by the thick frame.

The video displaying area 31 in this embodiment of the invention will be described with reference to FIG. 5C. The video displaying area 51 is used to display the video image stored in the image storage distribution server 1 or the live video image produced from the cameras. The camera number displaying area 52 is used to display the camera number of the currently displayed Web camera 5. The video status displaying area 53 is used to display the video status (live, playback (forward, reverse, fast forward, rewind), and stop). The video time displaying area 54 is used to display the time of the video that is currently displayed, for example, the camera's image picking up time. The camera name displaying area 55 is used to display the registered name of the current Web camera 5. This registered name of Web camera 5 is read from the table storing memory 12 of the image storage distribution server 1. The video decryption-setting button 56 is the setting box call button to decrypt the encrypted video image. The manual recording start/stop button 57 is the button to start the currently displayed Web camera 5 to record or stop the camera.

Since this manual recording can be made by only the user having the administrator power, the manual recording start/stop button 57 is not displayed in the video displaying area 31 of the monitoring screen of the client terminal 6 that has entered a password of general user power in the login dialog box. Thus, the video pictures from the Web cameras 5 can be suppressed from being freely recorded in the server 1 by an unspecified number of users. Consequently, the storage capacity and contents of the disk unit 3 can be properly managed.

FIG. 6 shows a decryption setting dialog box that is displayed when the video decryption setting button 56 is depressed by any input device such as the mouse. If a correct password is entered, the operator can decrypt the encrypted video or not.

The video operation area 32 will be described.

FIG. 7 shows the details of the video operation area in this embodiment of the invention. On the video operation area 32, the operator makes the operations about the status of the video displayed on the video displaying area 31. The 1-screen/4-screen switching button 71 (having a single-screen switching button shown to the left side and a four-screen switching button shown to the right side) is the button to switch the display type of video displaying area 31 from 1 screen to 4 screens or four screens to 1 screen. The display type can be changed when each button is clicked by using the mouse. FIG. 7 shows the state in which the single-screen switching button is selected. The video displaying area 31 thus becomes a single full screen. For example, when the monitoring screen is started, the defaults of the display type, registered camera number and video status are, respectively, the single full screen, the smallest number, and live. When the four-screen button is initially clicked, the most recent 4-screen registered pattern of live video is displayed as described later. Subsequently, the previous camera numbers are kept each time the 1-screen/4-screen switching is made, and live video from the Web cameras 5 are displayed.

On the video status operation area 72, the operator makes the operations about the status of the video displayed on the video displaying area 31. When the video displaying area 31 displays four-screen type video pictures, the operator makes the operations about the currently selected one of the four screens. The possible status modes include playback (forward, reverse), fast forward, rewind, movement to the start point/terminal and pause. For fast-forward and rewind, the playback speed can be specified as 2/5/10/30/60/180/600/1200 times normal speed by the combo box. In addition, the operator can manipulate video pictures frame by frame for forward and backward step of single frame.

The LIVE video button 73 is the button to set the status of the video currently displayed on the video displaying area 31 for the live video. When the video displaying area 31 displays video on the four divided screens, the operator can make the currently selected screen active for live video.

The SYNCH ON/OFF button 74 is used to set the synch status of video displaying area 31 for ON/OFF. Only when the video displaying area 31 displays video on the four divided screens, the operator can make the synch status ON. When the video displaying area 31 is switched to the single full screen under the ON-state of the synch status, the synch status is automatically changed to OFF. Here, the “SYNCH” function means that 4-screen video images can be displayed by manipulating the time base produced on the basis of the video time displayed on the currently selected screen, or that all video images on the four screens can be operated by the operation of one selected screen. The multiple operation area 33 will be described next. The multiple operation area 33 is used to make sophisticated operations on the video displaying area 31.

The camera selecting function of the multiple operation area 33 will be first described with reference to FIG. 8. The camera information stored in the image storage distribution server 1 is loaded to the client terminal 6 at the start of monitoring screen. The loaded information is used to display, on the multiple operation area 33, camera selection buttons (square buttons with numbers respectively attached at their centers as indicated in FIG. 8) for selecting the Web cameras 5 to be displayed on the video displaying area 31, and the recording status (for example, alarm mode, normal mode and so on) at each camera. Here, the alarm mode is, for example, the recording mode in which the recording is started when an external sensor detects something. The normal mode is, for example, the recording mode in which the recording is made according to the manual recording or schedule reservation. The image storage distribution server 1 is able to register an arbitrary number of camera numbers. In the example shown in FIG. 8, the camera numbers ranging from 1 to the maximum 16 can be registered in the server 1. In addition, for example, it is possible to set a single one of Web cameras 5 for two modes of normal mode and alarm mode or for a single mode of normal mode or alarm mode. Each of the normal mode and alarm mode can be indicated. The normal mode is indicated during either one of schedule recording and manual recording by lighting (in FIG. 8, the dot shown to the right of “REC” is lighted). The alarm mode is indicated only during the alarm recording by lighting (in FIG. 8, the dot shown to the right of “Alm” is lighted). If the operator can recognize the recording status visually or acoustically, other means than lighting may be used.

The process for displaying the recording status shown in FIG. 8 will be described with reference to FIG. 22. The process for displaying the recording status of the main image area of the video displaying screen is started periodically (for example, one second) during the time in which the client terminal 6 is displaying the main image area on the video displaying screen (STEP 2201).

The client terminal 6 requests the image storage distribution server 1 to send data necessary for displaying the recording status (STEP 2202).

The server 1, when receiving this request through the network interface 14 (STEP 2203), causes its processor 10 to make the counter i 0 in order to examine the recording status of each camera (STEP 2204).

The server 1 checks if the i-th camera starts to process for the video recording. The server 1 causes the table storing memory 12 to store the recording status data of “1” if the camera is recording or “0” if the camera is not recording (STEP 2205). Then, the server 1 causes counter i to increment by 1 (STEP 2206). The server 1 repeats the above operation until the value of the counter i reaches the maximum value previously set. Thus, it causes the table storing memory 12 to store the recording status data of all cameras (STEP 2205-2207).

After the recording status data of all cameras have been recorded, the server 1 produces replay data with the recording status data added (STEP 2208), and transmits the replay data to the client terminal 6 (STEP 2209).

The client terminal 6, after receiving the replay data (STEP 2210), causes the counter j for displaying the recording status data of each camera to be 0 (STEP 2211).

The client terminal 6 acquires the recording status data and judges whether the j-th camera is recording in the normal mode (STEP 2212). If it is recording in the normal mode, the client terminal 6 makes, for example, a dot lamp be lighted red on the video-displaying screen, thus indicating this fact (STEP 2213-2214). Although not shown in FIG. 22, the client terminal 6, if it is judged in STEP 2213 that the camera is not recording in the normal mode, may indicate this judgment result.

The client terminal 6 acquires the recording status data for judging whether the j-th camera is recording in the alarm mode (STEP 2215). If it is recoding in the alarm mode, the client terminal 6 causes, for example, an orange-color dot lamp to be lighted on the video displaying screen, thus indicating this fact (STEP 2216-2217). Although not shown in FIG. 22, the client terminal 6, if it is judged that the camera is not recording in the alarm mode in STEP 2216, may indicate this judgment result.

The client terminal 6 causes the counter j to increment by 1 (STEP 2218). The client terminal 6 repeats the above operation until the value of the counter j reaches the maximum value previously set. Thus, it displays the recording status of all cameras (STEP 2212-2219).

The four-screen pattern selecting function of the multiple operation area 33 will be described with reference to FIG. 9. The four-screen patterns registered in the server 1 by using registration boxes that will be described later are loaded to the client terminal 6 at the start of the monitoring screen. The client terminal 6 displays, as shown in FIG. 9, buttons (four-screen pattern selection buttons) for selecting cameras of four screens at a time when the video displaying area 31 is displaying four screens, and the names of patterns that can be registered. The operator depresses any four-screen selection button by the mouse or the like, thus the selected content being reflected on the video displaying area 31. When the video display area 31 is displaying the single screen, the client terminal 6 automatically switches the screen to the four-screen displaying status. In the example shown in FIG. 9, the four-screen pattern selection buttons can be displayed to provide the maximum of 8 patterns.

FIG. 10 shows the registration setting image for the four-screen patterns in this embodiment of the invention. The operator, by using this setting image, can set the contents of each pattern (to select the Web camera number of each of the upper left, upper right, lower left and lower right screens, the pattern number, to attach the pattern name and to decide the presence or absence of the pattern selection buttons in the multiple operation area 33). Then, the operator can register the settings in the image storage distribution server 1. Here, when the settings are as shown in FIG. 10, the multiple operation area 33 displays as shown in FIG. 9.

The process for setting the above four-screen patterns will be described with reference to FIG. 23.

The client terminal 6 starts this process when the link is selected to call the boxes for setting the four-screen patterns (STEP 2301).

The client terminal 6 requests the image storage distribution server 1 to send the four-screen patter setting boxes (STEP 2302). The server 1, when receiving this request (STEP 2303), acquires the data associated with the setting of the four-screen patterns (STEP 2304).

The server 1 generates the four-screen pattern setting boxes based on this data (STEP 2305), and transmits them to the client terminal 6 (STEP 2306).

The client terminal 6 displays the received boxes (STEP 2307, 2308).

When the operator sets four-screen patterns and depresses the setting button (STEP 2309), the client terminal 6 generates data of set four-screen patterns (STEP 2310), and transmits it to the server 1 (STEP 2311, 2312).

The server 1 writes the contents of the received data of four-screen patterns in the four-screen pattern setting data region of the table storing memory of the server 1 (STEP 2313).

The server 1 may authenticate the client terminal 6 so that each user can set the four-screen patterns. In this case, the server 1 causes the table storing memory to hold the four-screen pattern setting data of each user.

The process for acquiring the registered four-screen pattern data will be described with reference to FIG. 24.

The process is started when the video displaying area is displayed on the client terminal 6 (STEP 2401).

The client terminal 6 requests the server 1 to send the registered four-screen pattern data (STEP 2402).

The server 1, when receiving this request through the network interface 14 (STEP 2403), reads the registered four-screen pattern data from the four-screen pattern setting data of the table storing memory (STEP 2404).

The sever 1 generates replay data to the client on the basis of the read registered four-screen pattern data (STEP 2405), and sends it back to the client terminal 6 (STEP 2406).

The client terminal 6 receives the registered four-screen pattern data from the server 1 (STEP 2407). Then, when the tag of the four-screen pattern is depressed on the client terminal 6, the client terminal 6 starts to process for displaying the four-screen selection boxes (STEP 2501).

The client terminal 6 displays the four-screen pattern selection box (FIG. 9) based on the registered four-screen pattern data received from the server 1 (STEP 2502).

The client terminal 6 judges whether either one of the four-screen patters is selected (STEP 2503).

When either one of the four-screen patterns is selected, the client terminal 6 starts to display the four-screen pattern based on the selected four-screen pattern.

The process for displaying the four-screen pattern will be described with reference to FIG. 26.

This process is started (STEP 2601) when any four-screen pattern is selected from the four-screen pattern selecting box (FIG. 9) or when the client terminal 6 selects the four-screen (when the four-screen switching button 71 is depressed). When the four-screen switching button 71 is depressed, the client terminal 6 selects the four-screen pattern previously used or the four-screen pattern of the smallest pattern number of the four-screen patterns registered in the server 1.

First, the client terminal 6 starts to process targeting the upper left screen (STEP 2602). The client terminal 6 acquires the upper left camera number of the four-screen pattern (STEP 2603), and orders the server 1 to acquire the video from that camera number (STEP 2604).

The server 1 acquires the video data of that camera number from the data storing memory 13 (when the recorded video is reproduced, the server 1 acquires it through the disk interface 15 from the disk unit 3 (STEP 2605, 2606), and sends it back to the client terminal 6 (STEP 2607).

The client terminal 6 causes the video data sent back to be written in the upper left area of the memory for use in displaying data so that it can be displayed on the screen of client terminal 6 (STEP 2608-2610).

The client terminal 6, after having newly displayed on the upper left area of the video displaying area, newly displays on the upper right, lower right and lower left areas (STEP 2612-2617).

When the operator selects the single screen during this operation (YES in STEP 2611), the client terminal 6 ends the four-screen pattern displaying process (STEP 2618).

The automatic scanning (camera-switching) function of the multiple operation area 33 will be described with reference to FIGS. 11A-11C. The automatic scanning function includes a one-screen automatic scanning function and a four-screen automatic scanning function. The one-screen automatic scanning function automatically switches the cameras at intervals of a unit time and displays the live video from each Web camera 5 while the video displaying area 31 is displaying the single screen. The four-screen automatic scanning function automatically switches the four-screen patterns at intervals of a unit time and displays the live video pictures from the four Web cameras registered in each pattern while the video displaying area 31 is displaying the four screens.

The operator first pushes the one-screen automatic scan/four-screen automatic scan switching check button in the automatic scan menu box to select an automatic scanning function to be used. The operator clicks the “ONE SCREEN TIME” button of the buttons shown to the left end of FIGS. 11A-11C by the mouse or clicks the “FOUR-SCREEN TIME” button by the mouse, thereby making it possible to select the one-screen automatic scanning function or four-screen automatic scanning function. FIGS. 11A and 11B show the state in which the one-screen automatic scanning function is selected, and FIG. 11C the state in which the four-screen automatic scanning function is selected.

The client terminal 6 displays the check buttons (with camera numbers added) for selecting any ones of the Web cameras to be automatically scanned in the one-screen automatic scanning function mode, the combo box for selecting any ones of the camera selection switching time settings, and the scan start/stop buttons. The cameras that can be selected are the cameras registered in the image storage distribution server 1. The possible unit time settings are, for example, 5/10/15/20/30 seconds. When the scanning is started in the state in which the video displaying area displays the four screens, the one-screen displaying mode automatically replaces the four-screen mode. In FIG. 11A, the camera numbers 1˜10 are indicated on the check buttons. As illustrated in FIG. 11B, the Web cameras of camera numbers 1, 3 and 5 are set as the Web cameras to be automatically scanned.

The settings shown in FIG. 11B are stored as the table shown in FIG. 12A in the table storing memory 12 of the server 1. The table storing memory 12 also stores a table for managing the IP addresses of the respective camera numbers as, for example, shown in FIG. 12B. The automatic scanning is made according to these contents.

The client terminal 6 displays the check buttons (with the pattern numbers added) for selecting the four-screen patterns to be used for the automatic scanning in the four-screen automatic scanning function mode, the combo box for selecting the pattern selection switching time settings, and the scan start/stop buttons. The four-screen patterns that can be selected are the patterns registered in the server 1. The video displaying area 31 automatically switches to the four-screen displaying mode when the scanning is started in the one-screen displaying mode. FIG. 11C shows the state in which the four-screen pattern numbers 1˜8 are indicated on the check buttons. While the check buttons with the pattern numbers added are shown in FIG. 11C, the displaying mode is not limited to this example, but may be shown by, for example, the four-screen pattern selection buttons of FIG. 9 in which the camera numbers of Web cameras 5 are indicated on the four upper left, upper right, lower left and lower right divisions of each button.

When the operation on video or movement of video to other screen is forced during the automatic scanning, the client terminal 6 stops scanning. When the depression of automatic scan stop button or other buttons causes the scanning to stop, the video display area 31 takes the status in which the live video is displayed from the last Web camera 5 or last four-screen pattern.

The process for the automatic scanning will be described with reference to FIG. 27.

The automatic scanning process is started when the button for automatic scanning is depressed on the client terminal 6 (STEP 2701).

Judgment is made of whether the one-screen scanning mode or four-screen scanning mode is selected (STEP 2702). The case in which the four-screen scanning mode is selected will be described later.

When the one-screen scanning mode is selected, the client terminal 6 acquires the camera number of the camera to be first selected of the cameras to be scanned, and requests the server 1 to send the video of this camera number (STEP 2703, 2704).

The server 1 acquires the video data of the received camera number from the data storing memory 13 (acquires from the disk 3 through the disk interface 15 when the recorded video is reproduced) (STEP 2705, 2706), and sends it back to the client PC (STEP 2707).

The client terminal 6 causes the memory for use in displaying data to write the video data sent back, and makes the video data be displayed on the screen (STEP 2708-2710).

When judging that the displaying time exceeds the preset time (YES in STEP 2712), the client terminal acquires the next camera number to be selected, and goes back to the process of STEP 2704 where the client terminal continues to process.

This process is repeated until the stop button is depressed (STEP 2711).

The process for the case when the four-screen pattern-scanning mode is selected will be described with reference to FIG. 28.

The client terminal 6 first acquires the pattern number of which the cameras to be scanned are first selected (STEP 2801), and starts to process targeting the upper left screen of which the video is to be updated (STEP 2802). The client terminal 6 acquires the camera number of the upper left screen of the four-screen pattern (STEP 2803), and orders the server 1 to acquire the video of that camera number (STEP 2804).

The server 1 acquires the video data of the camera number from the data storing memory 13 (acquires from the disk 3 through the disk interface 15 when the recorded video is reproduced) (STEP 2805, 2806), and sends it back to the client terminal 6 (STEP 2807).

The client terminal 6 causes the memory for use in displaying data to write the video data sent back on its upper left area, and makes the video data be displayed on the screen (STEP 2808-2809).

When the operator selects the one-screen displaying mode or depresses the stop button during the above operation (YES in STEP 2810), the client terminal 6 ends the automatic scanning operation (STEP 2819).

When the displaying time exceeds the preset time (YES in STEP 2811), the client terminal 6 acquires the next pattern number to be selected (STEP 2812), and goes back to the process of STEP 2802.

For continuous display, after the upper left side process in the video displaying area, the process for the upper right, lower left and lower right screens is performed (STEP 2813-2818).

The batch recording function of the multiple operation area 33 will be described with reference to FIG. 13.

FIG. 13 shows the setting box for the batch recording. In the batch-recording mode, a plurality of cameras are specified from the Web cameras 5 registered in the server 1, and started/stopped to manually record according to the embodiment of the invention. The setting box of FIG. 13 shows the check buttons (with camera numbers added) for selecting the Web cameras to be operated, the batch recording button for the start of recording, and the stop button for the stop of recording. FIG. 13 also shows the state in which the Web cameras 5 of camera numbers 2, 4 and 10 are selected. When the batch-recording button is depressed under this condition, the Web cameras of camera numbers 2, 4 and 10 are started to manually record. Only the stop button stops the manual recording. The stop button does not stop the schedule recording and alarm recording. In addition, if the operator depresses the stop button, it is possible to stop the manual recording started by other operators (users). When the user name used to login to the server 1 does not have the authority of recording, the setting box shown in FIG. 13 is not shown (hidden), and thus the operator cannot use the batch recording function. Therefore, the video from the Web cameras 5 can be suppressed from being arbitrarily recorded in the server 1 by an unspecified number of users. In addition, each operator (user) can properly manage the storage capacity and storage contents of the disk unit 3.

The process for the batch recording will be described with reference to FIG. 29.

The process for the batch recording is started when the batch-recording button is depressed in the batch recording tag of the client terminal 6 (STEP 2901).

The client terminal 6 acquires the first selected camera number displayed on the setting box, and requests the server 1 to send the video of that camera number (STEP 2902, 2903).

The server 1 starts the recording process for the received camera number to operate, and then sends the information indicative of having started recording back to the client terminal 6 (STEP 2904-2906).

The client terminal 6, after receiving the information sent back (STEP 2907), checks if there are other cameras for the batch recording (STEP 2908). If there is, the process goes back to STEP 2902.

The processes for STEP 2902-2908 are performed until the processes on all the cameras for the batch recording have been completely finished.

The video display setting function of the multiple operation area 33 will be described with reference to FIG. 14.

FIG. 14 shows the setting box in which “NON-ALARM” button, “PREFERENTIAL ALARM” button and “ALARM-ONLY” button are used to set how video image is displayed to the video input of two modes of normal mode and alarm mode that can be set for each Web camera. When “NON-ALARM” is selected, only the input video of normal mode is displayed, or the input video of alarm mode (alarm recording) is not displayed. When “ALARM-ONLY” is selected, only the input video of alarm mode is displayed on the contrary to the selection of “NON-ALARM”, or the input video of normal mode is not displayed. When the “PREFERENTIAL ALARM” is selected, the video of normal mode is displayed for the case of no video input of alarm mode, but the input video of alarm mode, if present, is preferentially displayed.

FIG. 14 also shows the state in which the “NON ALARM” is selected. For the monitoring system, for example, the video of alarm mode is important that is started to record when the external sensor detects an intruder. As illustrated in FIG. 14, the user of the client terminal 6 can easily select the important video from the buttons given the names based on the alarm mode, such as “NON ALARM” button, “PREFERENTIAL ALARM” button and “ALARM-ONLY” button.

The camera operation function of the multiple operation area 33 will be described with reference to FIG. 15. FIG. 15 shows the buttons for use in operating the Web cameras 5 registered in the server 1. If any one of the buttons for the operation of the Web cameras 5 of camera numbers 1˜6 shown in FIG. 15 is clicked by the mouse, another window pops up as a camera manipulation setting box so that the client terminal 6 can be connected to the Web camera 5 of the corresponding camera number to pan/tilt the camera.

The camera information displaying area 34 will be described next.

FIG. 16 shows the window of the camera information displaying area in the embodiment of the invention. The camera information displaying area 34 displays a list of Web cameras 5 registered in the image storage distribution server 1. The list of the names of Web cameras 5 is indicated in the camera information list area 161. In addition, each camera 5 can be selected from the list. When any one of the cameras is selected from the list, the Web camera 5 can be displayed in the video displaying area 31 as in the camera selection mentioned above. When the Web cameras 5 of the list have had the video inputted in the normal mode, the date of the video of the normal mode held in the server 1 is written as information in the column of “PERIOD”. If they do not have had the video inputted in the normal mode (for example, manual recording or schedule recording), a bar of “-” is written in the column. When the listed Web cameras 5 have had the inputted alarm-mode video, the client terminal 6 writes in the “ALARM” column the fact that the inputted alarm-mode video is stored in the server 1 or newly stored in the server 1 after the previous indication. In order for the operator to discriminate the respective states, the client terminal 6 displays “PRESENT” if the alarm-mode input video is stored, “NEW ARRIVAL” if the alarm-mode input video is newly stored, and “-” if the alarm-mode video is not stored or not inputted. The update of information is performed by, for example, pushing the update button of the alarm information list-displaying box of the information operation area 35 that will be described later. The help button 162 is used to call up the help for the function of this displaying box.

The process to inform the operator of the newly picked-up video signals will be described with reference to FIG. 30.

The process is started when the main screen picture of the information displaying area of the server 1 is displayed on the client terminal 6 or when the update button 186 of the alarm list is depressed on the information operation area 35 (STEP 3001).

The client terminal 6 requests the server 1 to send the newly arrived data of alarm video (STEP 3002).

The server 1 receives the request, and acquires the necessary user name of the user accounts (STEP 3003, 3004). The user accounts are the user information with which the client terminal 6 processed to login or the environmental information of the client terminal 6. The user information is data of user name, password, right to use, and access time.

The server 1 refers to the user name recorded in the table storing memory of the server 1 and data of the last access time to acquire the last access time of the received user name (the previous access time of the corresponding user) and data of the date and hour of the alarm recording of each camera (hereinafter, called the alarm recording date list data) (STEP 3005, 3006). At this time, the last access time is updated with the current time (STEP 3020). The server 1 generates reply data to the client terminal 6 on the basis of the previous access time and the alarm recording date list data, and sends it back to the client terminal 6 (STEP 3007, 3008).

The client terminal 6 receives the data sent back (STEP 3009), and sets the counter j for checking each camera to zero (STEP 3010).

It checks if the camera j is the camera for alarm recording. If it is the alarm-recording camera, checking is made of if there is the received alarm-recording data (STEP 3011, 3012). If there is no alarm-related data for any case, the bar symbol of “-” is written in the alarm column (STEP 3015).

If there is alarm data, judgment is made of whether the alarm data is newer than the last access of the user. If the judgment is yes, “NEW ARRIVAL” is written in the alarm column. If the judgment is no, “PRESENT” is written in the alarm column (STEP 3013-3016).

The content of counter j is incremented by 1 (STEP 3017), and then the same check is made for the next camera (STEP 3012-3016).

If all cameras have been checked (YES in STEP 3018), the process ends (STEP 3019).

If all cameras have been checked, the process ends (STEP 3018).

In the process shown in FIG. 30, the client terminal 6 judges (STEP 3014) whether there is alarm data newer than the last access time according to the previous access time and alarm recording date list data received from the server 1 in STEP 3008. While the client terminal 6 thus executes the process in STEP 3014, the server 1 may execute the judgment corresponding to STEP 3014 as another embodiment. That is, in this case, the server 1 judges whether there is alarm data that is newer than the last access time according to the previous access time and alarm recording date list data. Only the data indicating the above “NEW ARRIVAL” and “PRESENT” is transmitted to the client terminal 6. Thus, the “information about whether there is any video as alarm recording after the last access time” that is transmitted from the server 1 to the client terminal 6 may use the previous access time and alarm recording date list data or data itself that indicates “NEW ARRIVAL” and “PRESENT” or other type of data.

The information operation area 35 will be described next. This information operation area 35 is useful for making advanced type of operation on the server 1.

The date specification jump function of the information operation area 35 will be first described with reference to FIG. 17.

FIG. 17 shows an example of the setting box for making the jump operation (that searches the disk unit 3 for the picture taken at the corresponding date and hour by the camera of a specified camera number and displays it) with the date and hour specified on the video displayed in the video displaying area 31. When the video displaying area 31 displays four screens, this operation is performed on the selected screen and the Web camera 5 of which the video is displayed on the selected screen.

Here, as illustrated in FIG. 17, the operator selects the date specification jump, alarm list or download of the box option area 171 displayed in the information operation area 35. FIG. 17 also shows the state in which the operator has selected the data specification jump. The calendar 172 is useful for specifying the date of the frame to be jumped to. At the start time, this calendar shows the state in which the date of system time is selected as default. That is, the date of Oct. 24, 2003 is selected as shown in FIG. 17. The time specification combo boxes 173 are used to specify the time of the frame to be jumped to. At the start time, the system time is selected as default. The jump button 174 is used to jump to the aimed frame. If the operator depresses the jump button 174 by using the mouse, jumping is made to the desired frame of the date specified by the calendar 172 and the time specified by the combo boxes 173. If the video of the specified date, hours and minutes of the desired Web camera 5 is not recorded within the disk unit 3, the frame picture nearest to the specified date, hours and minutes is selected and displayed. After the specified image is displayed in the video displaying area 31 by the jump button 174, the video operation area 32 can also be used to reproduce the video that begins with this image.

The alarm information list displaying function of the information operation area 35 will be described with reference to FIGS. 18 and 19.

FIG. 18 shows the alarm information list-displaying box according to the embodiment of the invention. When the Web cameras 5 registered in the server 1 have input video of alarm mode, the server 1 stores the information of recorded input video of alarm mode as alarm information. When the alarm list is displayed, the list of alarm information is listed for each camera. The alarm information displayed as a list is limited to the recorded video stored in the server 1. If the recorded alarm video is erased or overwritten, the corresponding alarm information is not displayed.

If the alarm information stored in the server 1 has 50 or more video recordings, or video clips as a list unit, the display range switching area 182 displays the “previous 50 video clips” or “next 50 video clips” button. Thus, pushing this button to change the display range can allow the operator to search for the desired alarm information. When the alarm information is being displayed from the beginning one to the final 50^{th} one, the “previous 50 video clips” button is not displayed. When the alarm information of the last unit of 50 video clips is being displayed, the “next 50 video clips” is not displayed. In other words, if the alarm information stored in the server 1 is equal to or less than 50 video clips, both “previous 50 video clips” button and “next 50 video clips” button are not displayed.

The camera selection combo box 183 is used to select the Web camera 5 of which the alarm information is to be displayed. The operator selects the Web camera (the camera name in FIG. 18) of which the alarm information is desired to display by dropping the combo box down with the mouse. Only the Web camera 5 to be selected has the input video of alarm mode.

The alarm information list 184 displays a list of alarm information. Each video clip of the alarm information has the alarm information ID of each camera, the video storage start time and end time of input alarm-mode video, and the thumbnail picture of a frame of the alarm video. Each clip of the list can be selected. For example, the top clip of the list is selected as default at the start time. Even after the change of the display range, the top clip, for example, may be selected.

When the operator pushes the jump button 185, the frame jump is made to the beginning frame of the alarm video corresponding to the alarm information selected as the alarm information list 184 (searching of disk unit 3 is made for the corresponding frame video). At this time, when the video displaying area 31 displays a single full screen, the Web camera 5 of which the alarm information is to be displayed is selected, and then the client terminal 6 makes the frame jump. When the video displaying area 31 displays four screens, the Web camera 5 of which the alarm information is to be displayed is selected for the screens selected by the video displaying area 31, and then the frame jump is performed. At this time, the frame jump is performed for the input video of alarm mode. If the display type is “NON-ALARM”, the frame location is brought to the nearest to the normal-mode recorded video. If the frame location is desired to move to the correct frame position, the video display type is set to the “ALARM-ONLY” in the video setting box (FIG. 14).

The “UPDATE” button 186 is used to update the alarm information list. The latest alarm information of the Web camera 5 of which the alarm information is now displayed is reacquired and displayed. In addition, the update process is performed on the camera information of the camera information displaying area 34.

An example of how to use the alarm information list displaying area will be described with reference to FIG. 19.

As illustrated in FIG. 19, step 1 is performed to select arbitrary alarm information from the alarm information list 184. Then, step 2 is performed to depress the jump button 185 so that the frame jump is made to the location of the beginning frame of the recorded video (alarm video) corresponding to the alarm information selected from the alarm information list 184. In other words, since the video image corresponding to the selected alarm information is displayed in the video displaying area 31, step 3 can be carried out to confirm the contents of this alarm information.

Here, as shown in FIG. 19, the video displaying area 31 displays four screens. The upper left screen displays the picture of the alarm video. As the upper left screen of the four screens shown in FIG. 19 displays, the bottom column of the screen area that has the camera number displaying area 52, camera name displaying area 55 and so on is displayed in a different condition from when the normal mode video is displayed, for example, in a different color or in a blinking manner so that the operator can visually or acoustically recognize with ease that the displayed video is in the alarm mode.

In the monitoring system, for example, as described above, it is important to start alarm-mode video recording when the external sensor detects an intruder. Thus, since the alarm-mode video is displayed in this different manner than when the normal mode video is displayed, the user of the client terminal 6 can easily recognize whether the currently displayed video is of the alarm mode. While the bottom column is differently displayed in FIG. 19, any area of this screen may be displayed in a different manner, in which case the same effect can be achieved.

The download function of the information operation area 35 will be described with reference to FIGS. 20 and 21.

FIG. 20 shows the setting box for downloading video from the disk unit 3 according to the embodiment of the invention. This download function enables the video stored in the disk unit 3 to be stored (downloaded to) in a local disk on the client terminal 6 side. FIG. 20 shows the box for the setting. The download box may be displayed only when the video displaying area 31 displays the single full screen.

In addition, when we go to the download box, the video displaying area 31 may be automatically changed to the single full screen. When the four-screen mode is changed to while the download box is displayed, the download box may be finished and changed to the above-given date specification jump box.

The start point specification area 205 in FIG. 20 is the setting area to specify the start point of the range to be downloaded. The operator can set the video time of the video currently displayed in the video displaying area 31 as the start point by depressing the “INPUT” button of the start point specification area 205. If the operator depresses the jump button of the start point specification area 205, the frame location can be jumped to the date and time of the current start point.

The end point specification area 206 is the setting area to specify the end point of the range to be downloaded. The operation of the button is the same as that for the start point specification, and thus will not be described. The store destination-specifying button 207 is used to store the downloaded video in the local holder. When the operator depresses the “REFERENCE” button as the store destination-specifying button, a local holder specifying dialog box pops up. The download button 208 is used to download. The Web camera 5 of which the video is to be downloaded is the camera that is now being displayed in the video displaying area 31. When the camera of which the video is to be downloaded is set to be capable of either one of the normal mode input video and alarm mode input video or of both modes, the client terminal operates, for example, according to the display type set in the video displaying area shown in FIG. 14. When the “NON-ALARM” is set, the input video of normal mode is downloaded. When the “ALARM-ONLY” is set, the input video of alarm mode is downloaded. If the “PREFERENTIAL ALARM” is set or when only the alarm mode input video is set in the Web camera 5 with “NON-ALARM” or when only the normal mode input video is set in the camera with the “ALARM-ONLY”, the video is not downloaded.

Here, one example of how to use the above box to download will be described with reference to FIG. 21. As illustrated in FIG. 21, step 1 is performed to depress the jump button 174, so that the frame location is jumped to the picture frame specified by the calendar 172 and time specification comb box 173. In other words, the picture corresponding to the specified date and time is displayed in the video displaying area 31. Thus, step 2 is performed for the operator to confirm the specified date and time. Then, when the operator can judge that the confirmed video is satisfied, step 3 is carried out for the operator to depress the “INPUT” button of the start point specification area 205. Thus, the client terminal can set the video time of the video currently displayed in the video displaying area 31 as the start point. After similarly setting the end point, step 4 is performed for the operator to depress the download button 208, so that the desired video can be simply downloaded from the disk unit 3.

While the four-screen displaying mode is used on the single monitor screen in the above example, the present invention is not limited to this construction, but may take the displaying mode in which four video pictures can be displayed on four monitors, respectively.

Here, the video displaying method according to the invention is not limited to the above structure, but may take various different constructions. The present invention may provide a program or various apparatus such as the video displaying apparatus or system to achieve the method or system for executing the processes according to the invention.

In addition, the present invention is always not applied to the above field, but may be applied to various different fields. While the video generated from the cameras of the monitoring system is described as an example in the above embodiment, the present invention is not limited to the application to the above field. The invention can be applied to the video associated with, for example, movies and television programs.

While the above description is made about the embodiment, the present invention is not limited to the above, but can be variously changed and modified without departing from the spirit of the invention and from the scope of the claims as those who are skillful in the art can well understand.

### INDUSTRIAL APPLICABILITY

The present invention can be applied to various fields such as the field to deal with the video signals produced from the cameras of the monitoring system, and the field to handle the video signals associated with the movies and television programs.

### BRIEF DESCRIPTION OF THE DRAWINGS

FIG. 1 is a diagram showing the whole construction of the image storage distribution system according to an embodiment of the invention.

FIG. 2 is a diagram showing the construction of the image storage distribution server in the embodiment of the invention.

FIG. 3 is a diagram showing an example of the video displaying area in the embodiment of the invention.

FIG. 4 is a diagram showing an example of the login box in the embodiment of the invention.

FIG. 5A is a diagram to which reference is made in explaining the details of the video displaying area in the embodiment of the invention.

FIG. 5B is a diagram to which reference is made in explaining the details of the video displaying area in the embodiment of the invention.

FIG. 5C is a diagram to which reference is made in explaining the details of the video displaying area in the embodiment of the invention.

FIG. 6 is a diagram showing an example of the decryption-setting box in the embodiment of the invention.

FIG. 7 is a diagram to which reference is made in explaining the video operation area of the video displaying area in the embodiment of the invention.

FIG. 8 is a diagram to which reference is made in explaining the camera selection function of the video displaying area in the embodiment of the invention.

FIG. 9 is a diagram to which reference is made in explaining the four-screen pattern selection function of the video displaying area in the embodiment of the invention.

FIG. 10 is a diagram showing an example of the registration-setting box of the four-screen pattern in the embodiment of the invention.

FIG. 11A is a diagram to which reference is made in explaining the camera switching function of the video displaying area in the embodiment of the invention.

FIG. 11B is a diagram to which reference is made in explaining the camera switching function of the video displaying area in the embodiment of the invention.

FIG. 11C is a diagram to which reference is made in explaining the camera switching function of the video displaying area in the embodiment of the invention.

FIG. 12A is a diagram showing an example of the table that the image storage distribution server manages in the embodiment of the invention.

FIG. 12B is a diagram showing an example of the table that the image storage distribution server manages in the embodiment of the invention.

FIG. 13 is a diagram to which reference is made in explaining the batch recording function of the video displaying area in the embodiment of the invention.

FIG. 14 is a diagram to which reference is made in explaining the video display setting function of the video displaying area in the embodiment of the invention.

FIG. 15 is a diagram to which reference is made in explaining the camera operation function of the video displaying area in the embodiment of the invention.

FIG. 16 is a diagram showing an example of the video information displayed in the video displaying area in the embodiment of the invention.

FIG. 17 is a diagram to which reference is made in explaining the video search function of the video displaying area in the embodiment of the invention.

FIG. 18 is a diagram showing an example of the alarm information list representation of the video displaying area in the embodiment of the invention.

FIG. 19 is a diagram to which reference is made in explaining an example of how to use the alarm information list of the video displaying area in the embodiment of the invention.

FIG. 20 is a diagram to which reference is made in explaining the download function of the video displaying area in the embodiment of the invention.

FIG. 21 is a diagram to which reference is made in explaining the download function of the video displaying area in the embodiment of the invention.

FIG. 22 is a diagram showing an example of the video displaying process in the embodiment of the invention.

FIG. 23 is a diagram showing an example of the four-screen pattern displaying process of the video displaying process in the embodiment of the invention.

FIG. 24 is a diagram showing an example of the four-screen pattern data acquiring process of the video displaying process in the embodiment of the invention.

FIG. 25 is a diagram showing an example of the four-screen pattern data acquiring process of the video displaying process in the embodiment of the invention.

FIG. 26 is a diagram showing an example of the four-screen pattern-selecting box displaying process of the video displaying process in the embodiment of the invention.

FIG. 27 is a diagram showing an example of the automatic scanning process of the video displaying process in the embodiment of the invention.

FIG. 28 is a diagram showing an example of the automatic scanning process of the video processing apparatus in the embodiment of the invention.

FIG. 29 is a diagram showing an example of the batch recording process of the video processing apparatus in the embodiment of the invention.

FIG. 30 is a diagram showing an example of the alarm recording new arrival displaying process of the video processing apparatus in the embodiment of the invention.

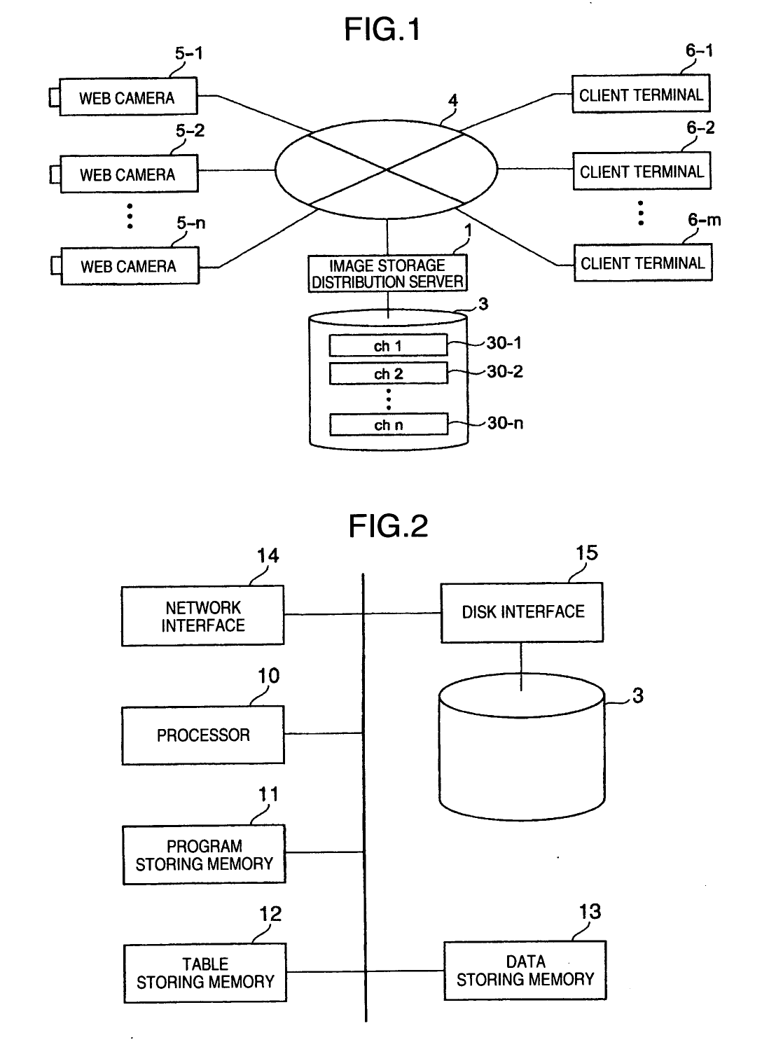

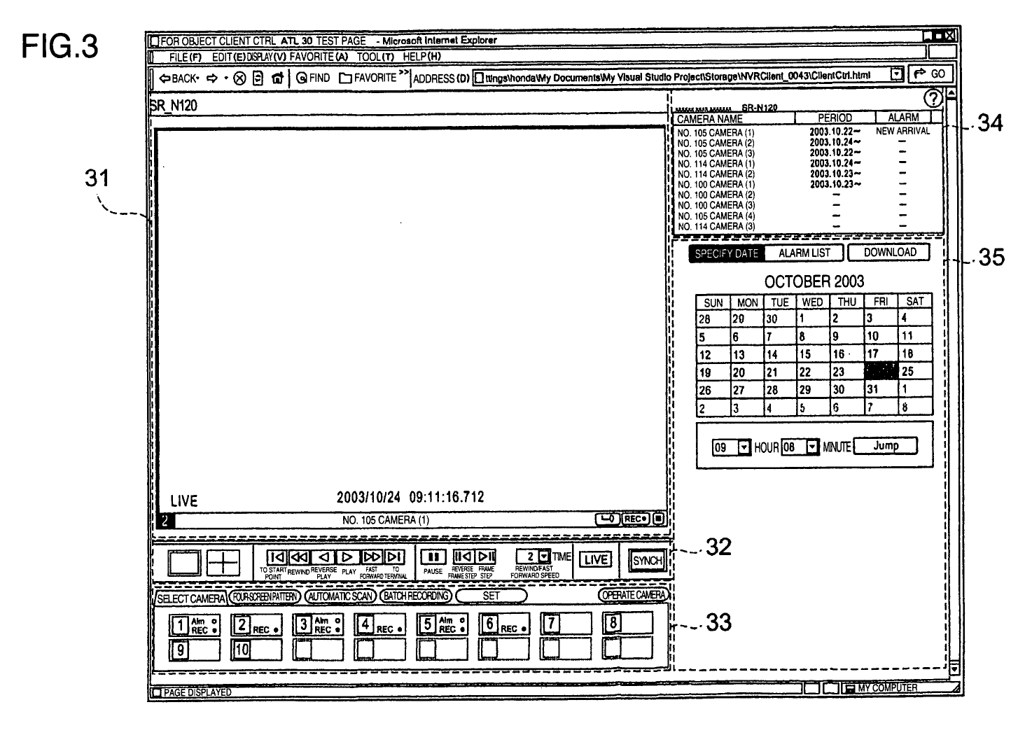

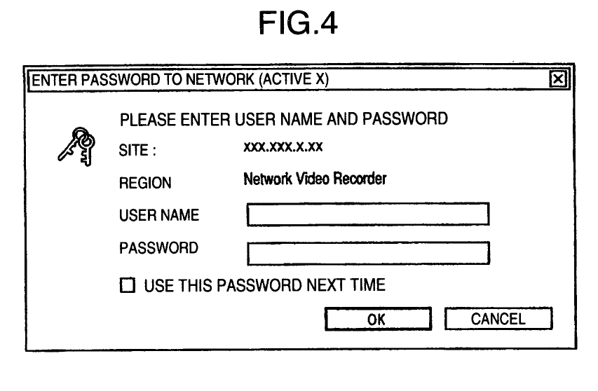

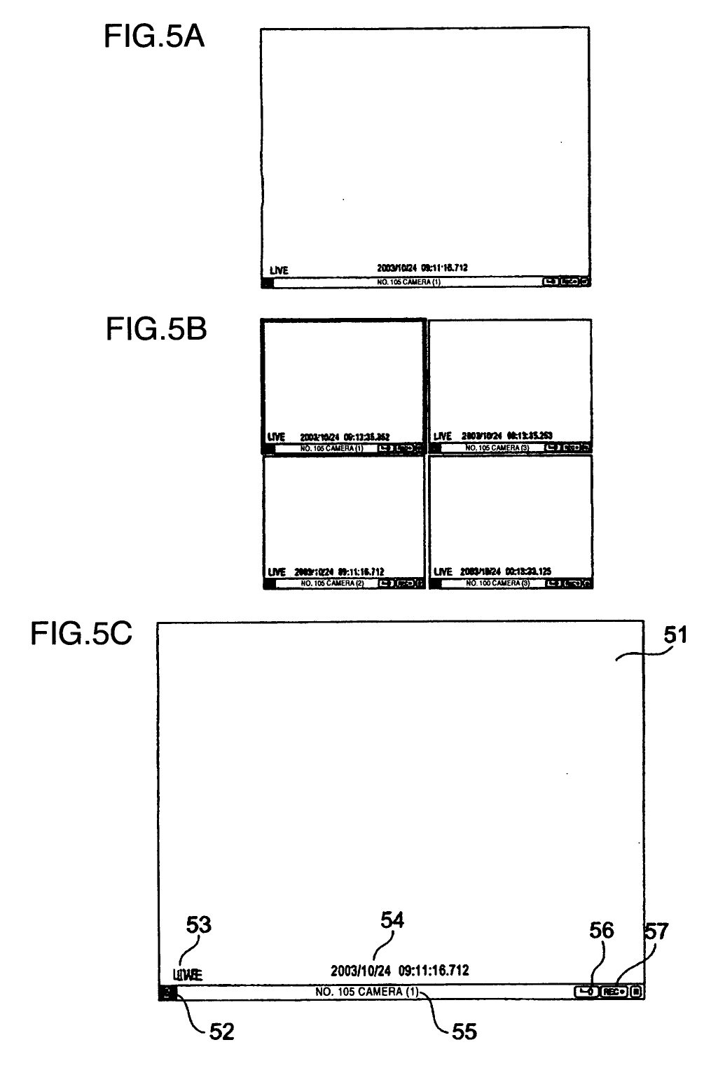

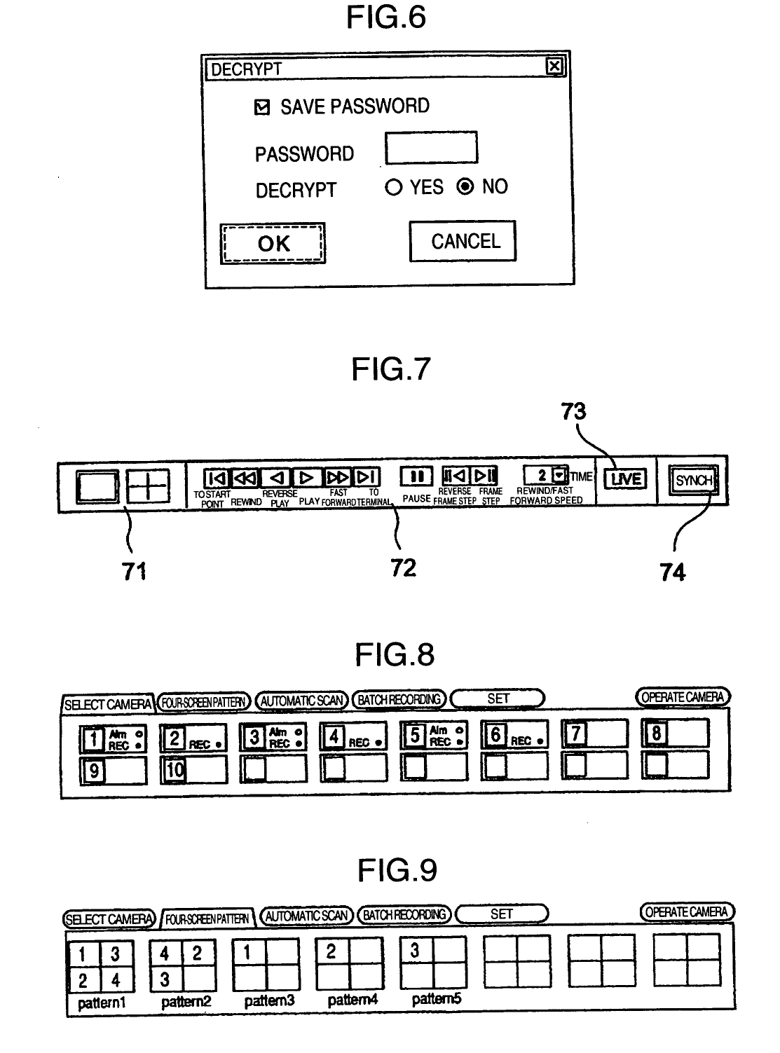

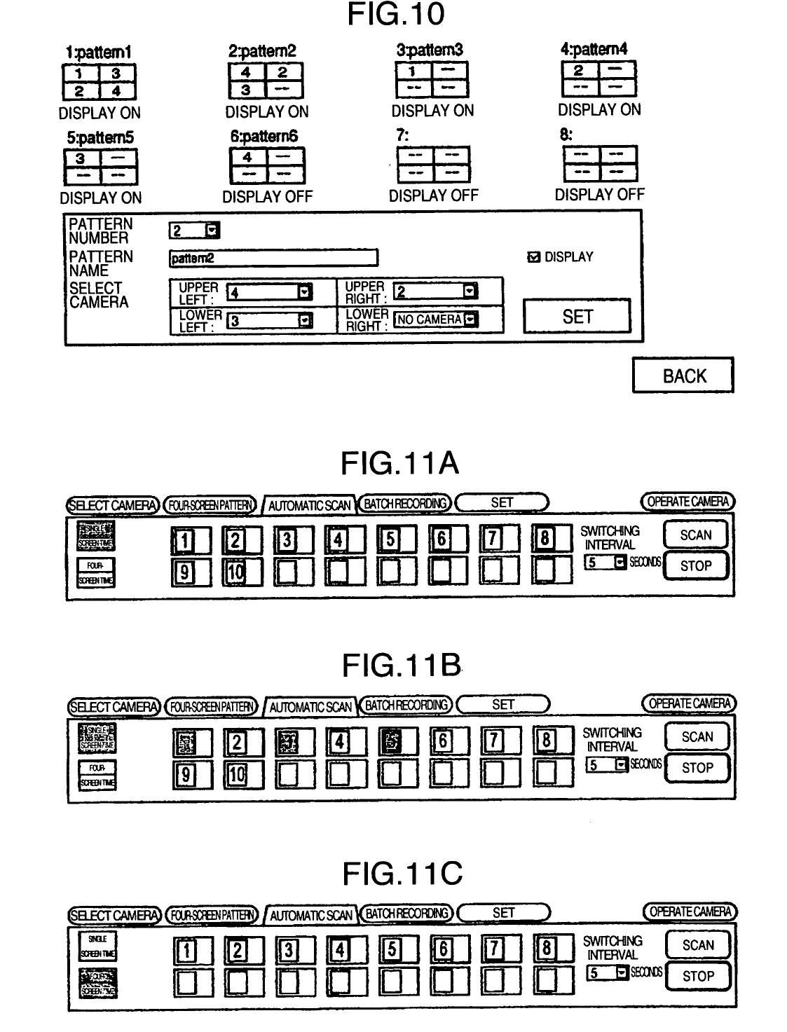

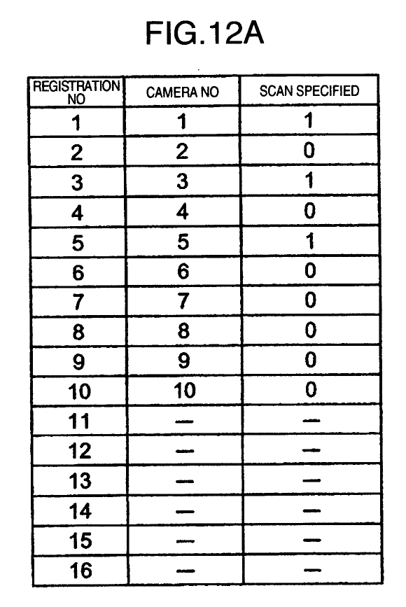

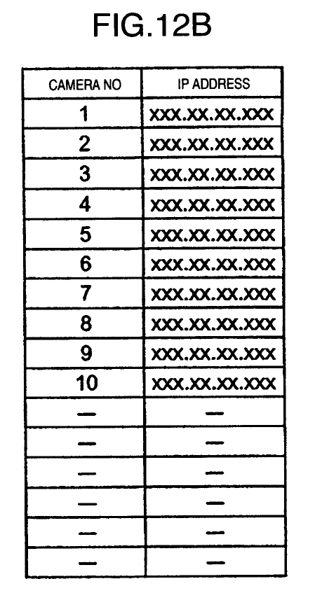

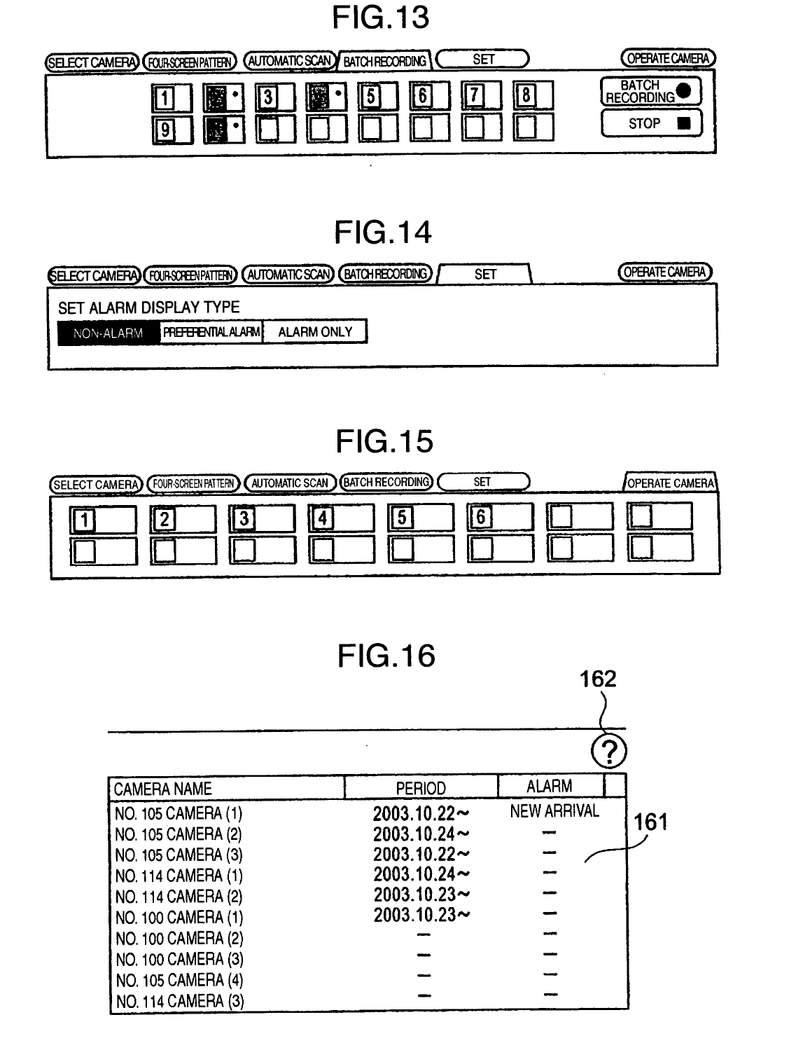

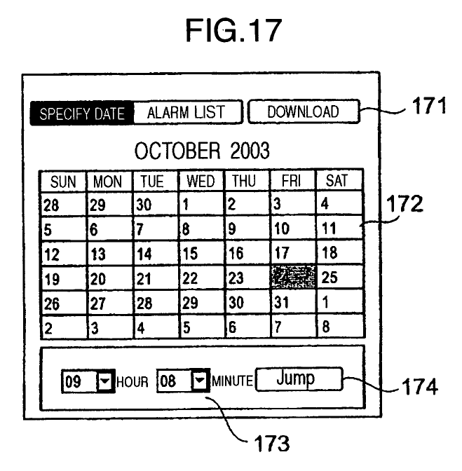

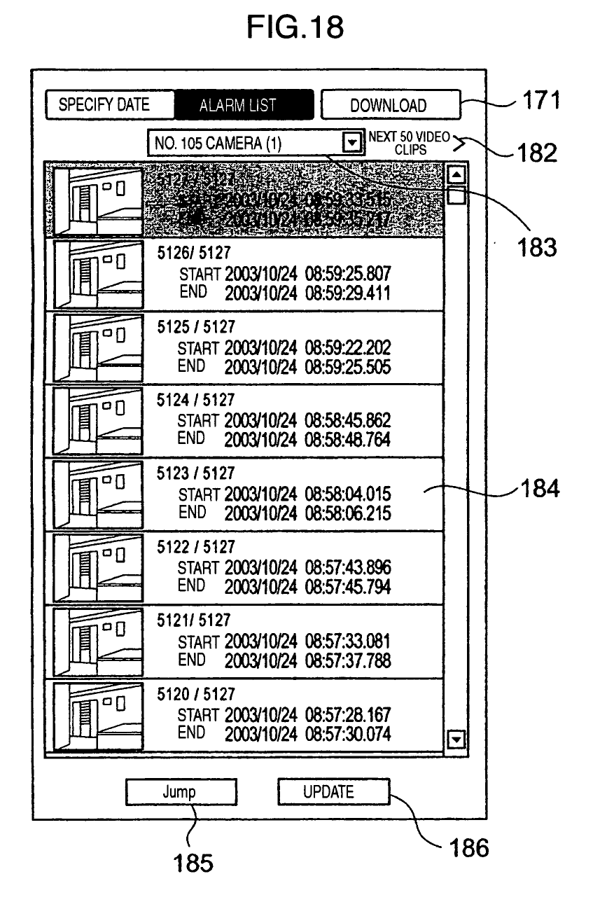

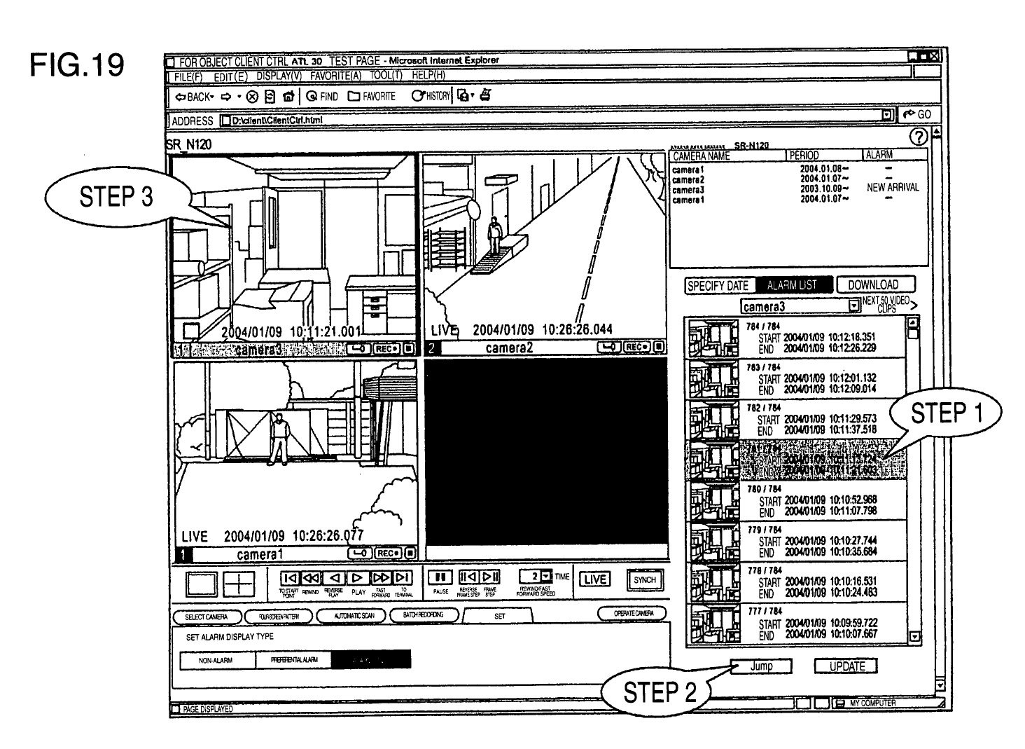

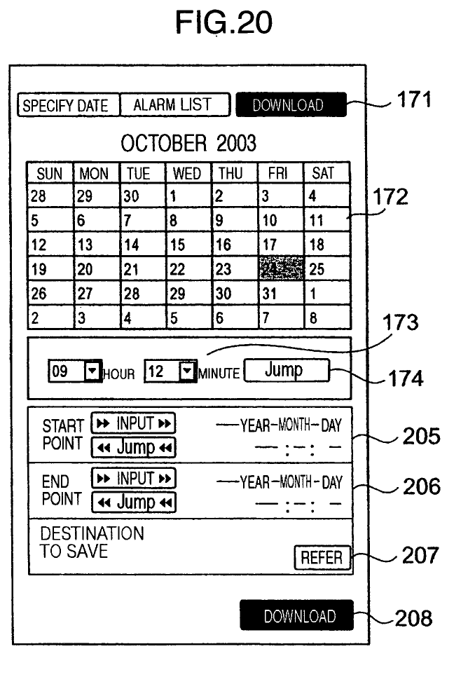

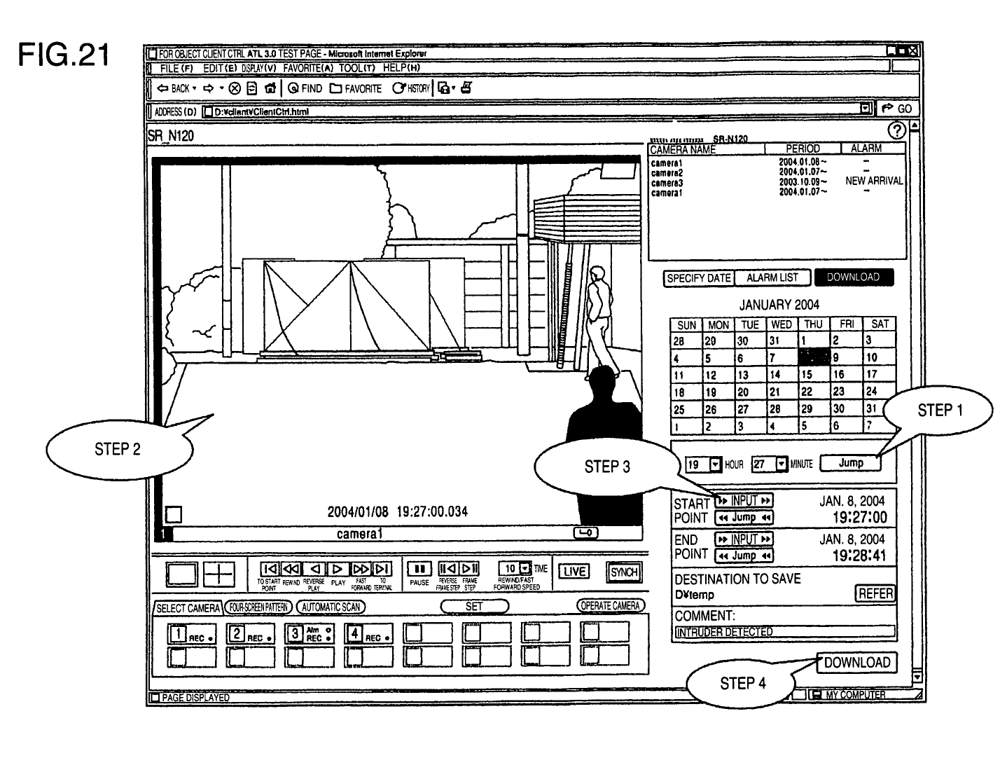

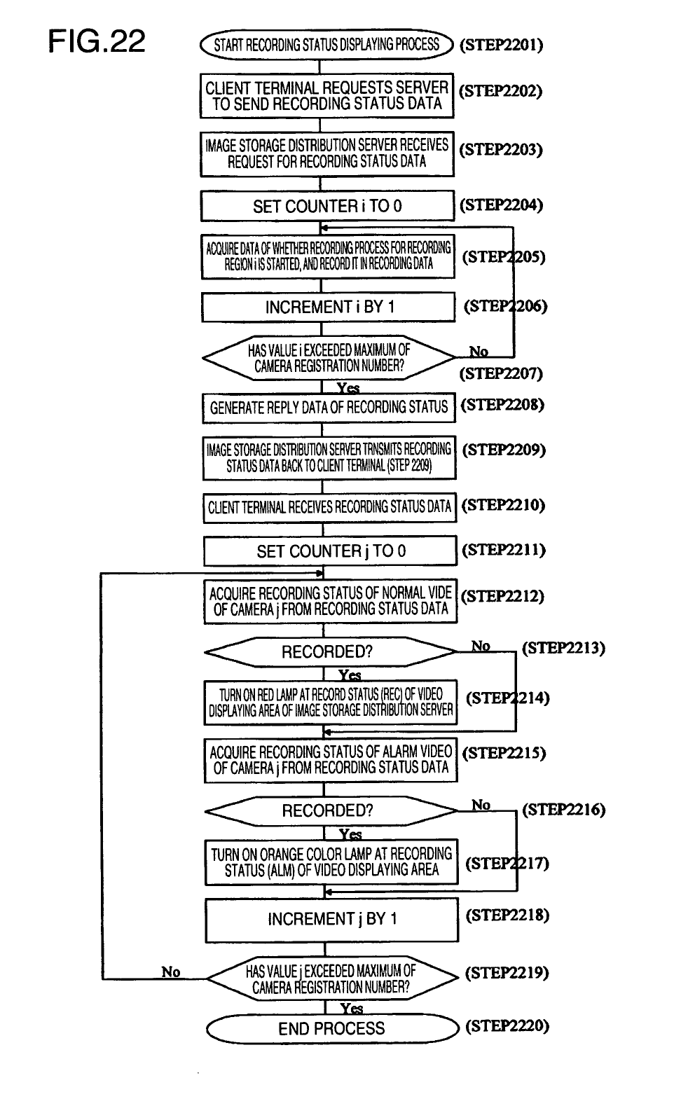

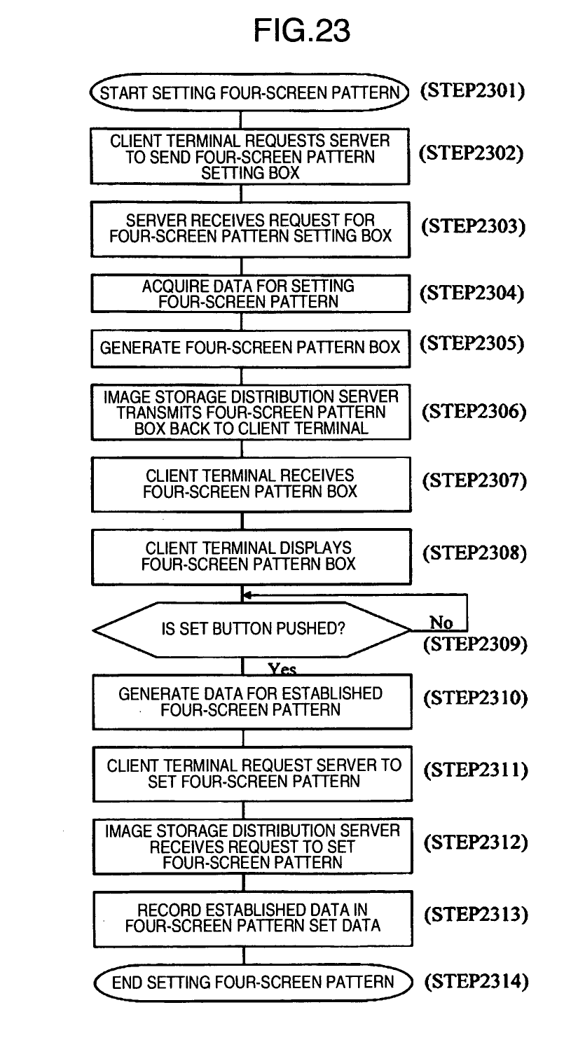

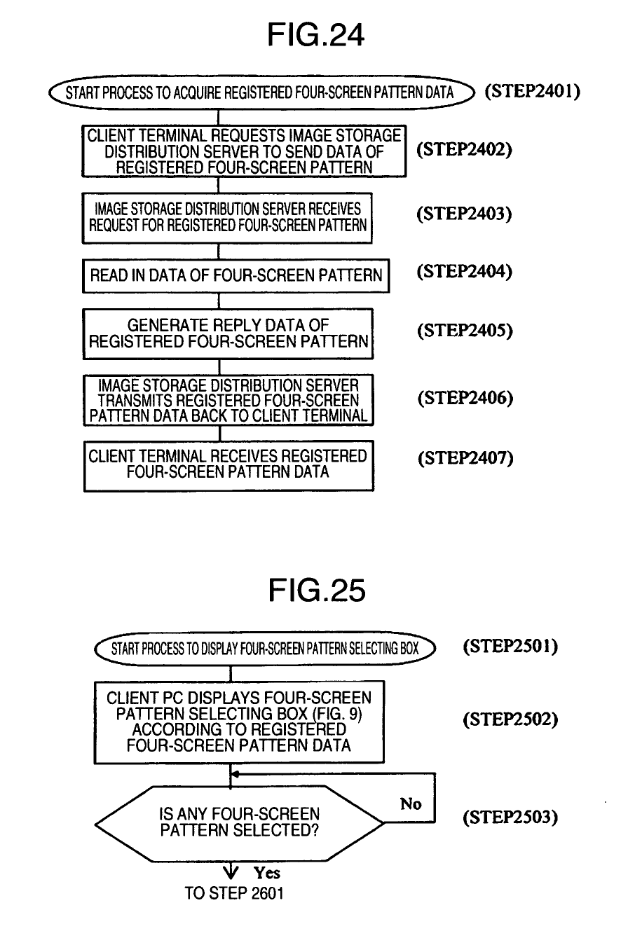

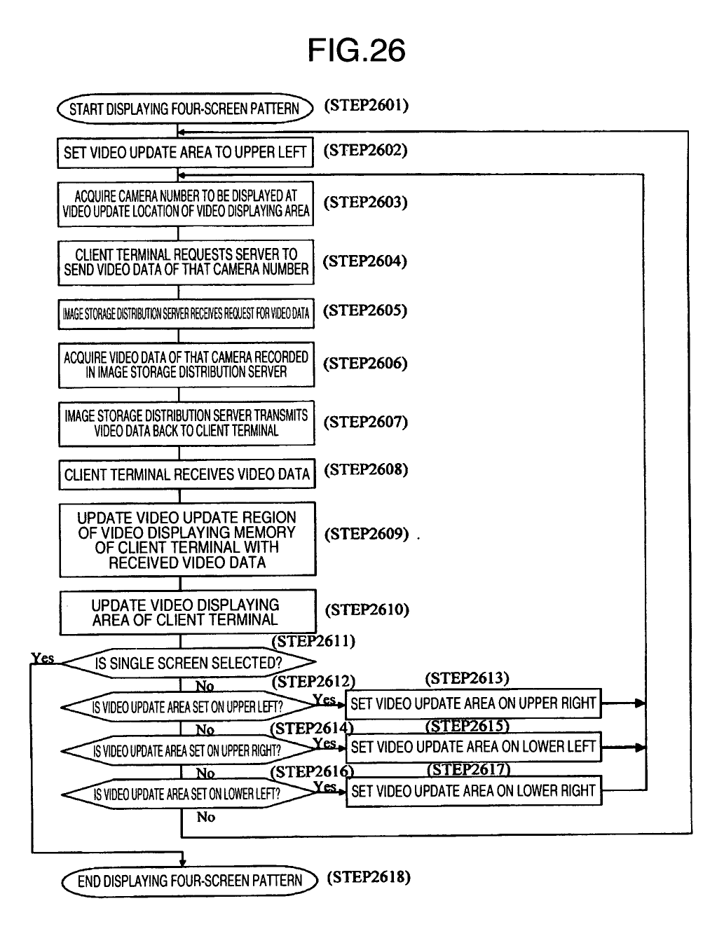

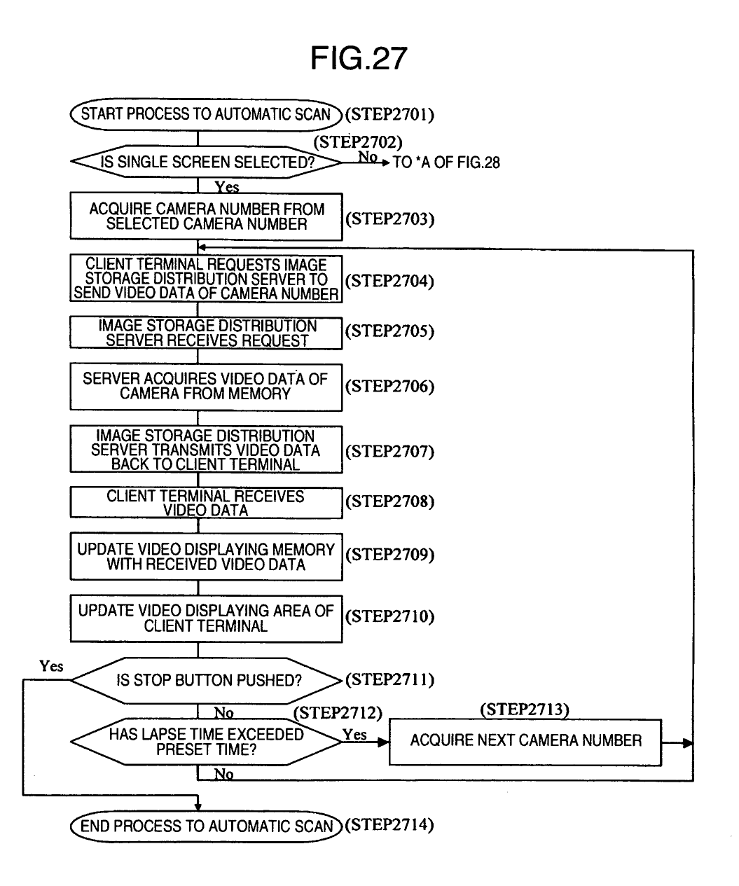

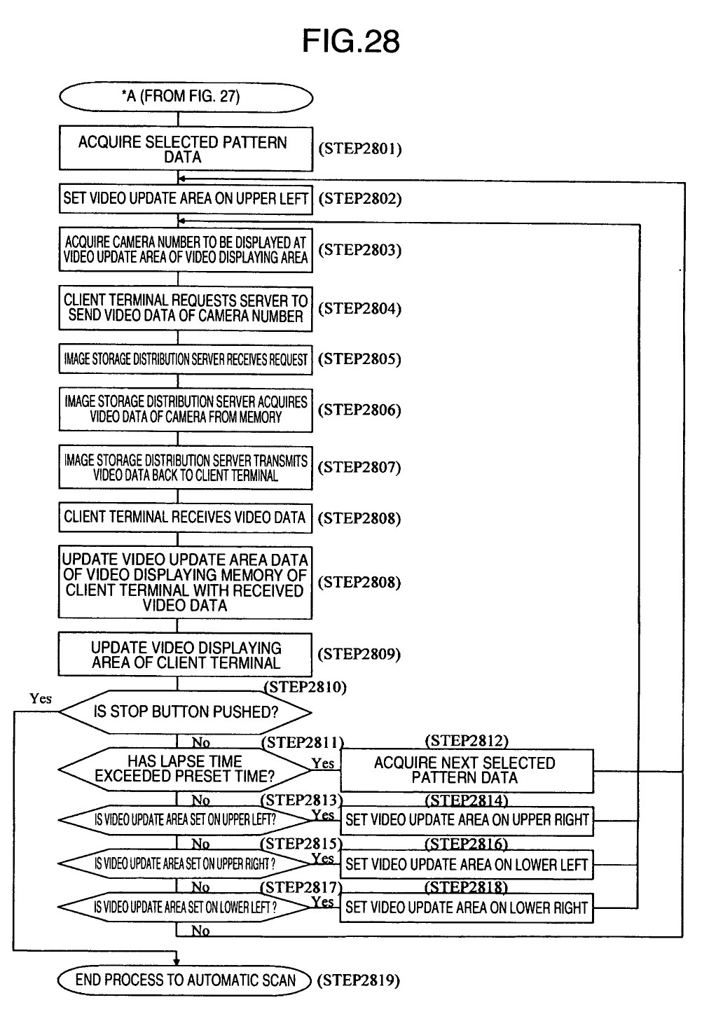

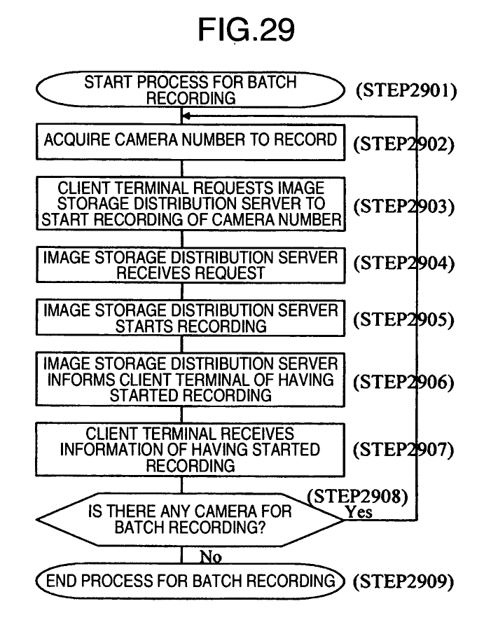

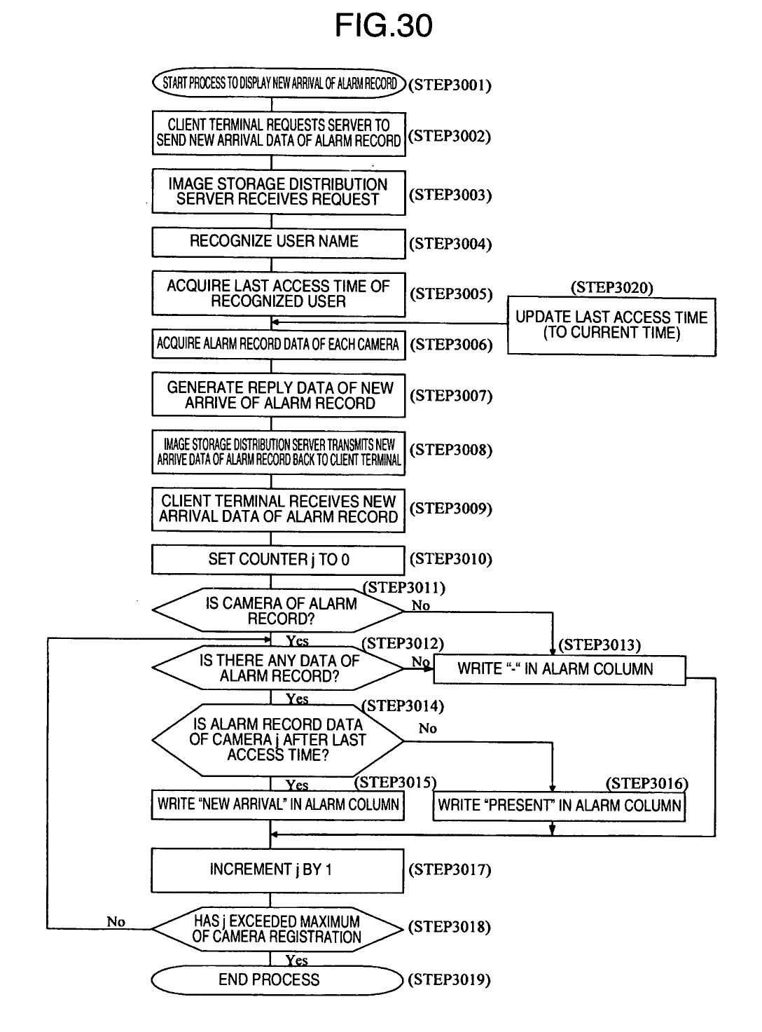

1. A video distribution system for distributing a video through a network to a client terminal, comprising:
video arrangement information registering means that registers video arrangement information of a plurality of video arrangements on a video displaying area based on a notice from the client terminal;
video arrangement information list transmitting means that transmits a list of the video arrangement information registered by the video arrangement information registering means to the client terminal; and
video distributing means that distributes the video to the client based on a video distribution request from the client terminal based on the video arrangement information selected by the client terminal from the video arrangement information list.

2. The video distribution system according to claim 1, further comprising video arrangement information setting box transmitting means that transmits to the client terminal a video arrangement information setting screen for setting the video arrangement information.

3. The video distribution system according to claim 2, wherein the video arrangement information setting box has a function to set an identification number of the video for displaying at each position in the video displaying area, and another function to set at least either one of an identification number and an identification name of the video arrangement information.

4. A video distribution system for distributing a video through a network to client terminals, comprising:
user information holding means that manages a plurality of user accounts and holds user information of each of the user accounts;
previous access time acquiring means that acquires a previous access time of the user account of the client terminal currently keeping to login based on the user information held by the user information holding means; and
alarm video presence information transmitting means that transmits to the client terminal, information of whether any alarm-recorded video exists after the acquired previous access time.
